(19) United States
(12) Patent Application Publication
(10) Pub. No.: US 2006/0077861 A1
(43) Pub. Date: Apr. 13, 2006

(54) Objective optical system for optical recording media, optical pickup optical system, and optical pickup device using the optical pickup optical system

(75) Inventors: Toshiaki Katsuma, Tokyo (JP); Yu Kitahara, Saitama City (JP); Masao Mori, Saitama City (JP); Tetsuya Ori, Koshigaya City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/244,292

(22) Filed: Oct. 6, 2005

(30) Foreign Application Priority Data
Oct. 8, 2004 (JP) 2004-296952

(51) Int. Cl. G11B 7/00

(52) U.S. Cl. 369/112.16; 369/44.32; 369/112.01

(57) ABSTRACT

An objective optical system focuses light from a light source onto at least two different types of optical recording media having different substrate thicknesses in order to record or reproduce information onto the optical recording media by using a different light convergence or divergence effect based on a difference in the vibrational direction of the polarization of polarized incident light. This difference may be caused by passing the light through a uniaxial crystal, such as crystallized quartz, that has its optic axis arranged to use an extraordinary ray and an ordinary ray that are subject to different refractive indexes in an objective optical system even though the rays have the same wavelength. Diffractive optics may also be used to enable excellent focusing on more than two recording media. An optical pickup optical system and an optical pickup device using this optical pickup optical system include the objective optical system.

### TECHNICAL FIELD OF THE INVENTION

The present invention relates to an objective optical system for optical recording media that, when recording or reproducing information, efficiently focuses light of different wavelengths onto an appropriate corresponding recording medium according to standardized characteristics such as the numerical aperture of the objective optical system used, the wavelength of the light selected, and the substrate thickness of the optical recording medium. The objective optical system focuses light beams with the same wavelength, or nearly the same wavelengths, onto different optical recording media with different characteristics, such as substrate thicknesses. The present invention also relates to an optical pickup optical system and an optical pickup device using the optical pickup optical system that use such an objective optical system.

### BACKGROUND OF THE INVENTION

In response to the recent development of various optical recording media, optical pickup devices that can carry out recording and reproducing using two alternative types of optical recording media have been known. For example, devices that record or reproduce information with either a DVD (Digital Versatile Disk) or a CD (Compact Disk including CD-ROM, CD-R, CD-RW) have been practically used. Furthermore, the DVD, in order to improve the recording density, is designed to use visible light with a wavelength of approximately 658 nm. In contrast, because there are also optical recording media that do not have any sensitivity to light in the visible light region, near-infrared light with a wavelength of approximately 784 nm is used for the CD. Further, with these two optical recording media, it is necessary to provide different numerical apertures (NA) due to the differences in the characteristics of the two optical recording media. Additionally, the substrate thickness, that is, the geometric thickness of a protective layer formed with PC (polycarbonate), of each of the two different optical recording media is standardized to a different thickness. For example, the substrate thickness of the DVD is 0.6 mm and the substrate thickness of the CD is 1.2 mm.

In addition, a semiconductor laser with a short wavelength (for example, that emits a laser beam with a wavelength of 408 nm) using a GaN substrate has been put into practical use, and in response to the demand for increasing recording capacity, AODs (Advanced Optical Disks), also known as HD-DVDs, that provide approximately 20 GB of data storage on a single layer of a single side of an optical disk by using this short wavelength light is about to be put into practical use. Further, a Blu-ray Disc (hereafter, referred to as ‘BD’) where a light with a short wavelength is used as an irradiation light similar to the AOD is almost ready to be put into practical use.

In the standards for AODs, the numerical aperture and the substrate thickness are standardized to the same values as those of DVDs, specifically a numerical aperture (NA) of 0.65 and a substrate thickness of 0.6 mm. In contrast, in the standards for BDs (Blu-ray disk systems), the numerical aperture (NA) and the substrate thickness are standardized to completely different values from the values for DVDs and CDs. Specifically, for BDs, the standard numerical aperture (NA) is 0.85 and the standard substrate thickness is 0.1 mm.

Therefore, an optical pickup device wherein any of three optical recording media (namely, an AOD, DVD and CD, or a BD, DVD and CD) can be used, has also been progressing.

As mentioned above, with these optical recording media, because the standardized wavelengths and substrate thicknesses differ from one another depending upon the type of optical recording medium being used, the spherical aberration generated by the substrates differs based on differences in thicknesses of the substrates (protective layers). Therefore, in these optical pickup devices, because it is necessary to optimize the spherical aberration relative to the light beams of various wavelengths in order to assure a proper focus onto the different recording media for recording or reproducing information, it is necessary to devise a lens configuration that has a different light convergence effect on each of the optical recording media for the objective lens for optical recording media mounted in these devices.

Applicants of the present invention have already suggested various objective lenses for optical recording media in the specifications of Japanese Laid-Open Patent Applications 2005-190620, 2005-158213, 2005-093030, 2005-149626 and 2005-100586. In the objective lenses for optical recording media of the Japanese applications listed above, light beams of different wavelengths are focused on the recording medium of each of the CD, the DVD, and the AOD (or the BD). This is achieved, for example, using an objective optical system for optical recording media that includes a diffractive optical surface, which has wavelength selectivity, and an objective lens in order to achieve optimization of corrections of spherical aberrations generated by differences in the thicknesses of the substrates (protective layers) of the optical recording media.

As mentioned above, since AODs and BDs are approaching practical use, there is a demand to be able to record and reproduce information using four types of optical recording media, that is, using AODs and BDs, in addition to CDs and DVDs, as the optical recording media using a single objective lens.

However, as mentioned above, light beams with the same wavelength, or very nearly the same wavelength, for example, 408 nm or very nearly 408 nm, are used for both AODs and BDs, and according to the teachings of the Japanese applications listed above, where the light convergence effects are changed based on differences in wavelengths of the light beams being used, the use of the same wavelength, or very nearly the same wavelength, does not support using both a BD and an AOD with a single objective lens.

Therefore, it is necessary to adopt new concepts in order to realize an objective lens for optical recording media that can be used for at least both an AOD and a BD.

### BRIEF SUMMARY OF THE INVENTION

The present invention relates to an objective optical system for optical recording media that can efficiently focus light beams of the same wavelength, or very nearly the same wavelength, on different recording media with different technical standards of the substrate thickness. The present invention further relates to an optical pickup optical system and an optical pickup device using the optical pickup optical system that uses such an objective optical system.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A-1D are schematic diagrams that depict cross-sectional views of the objective optical system of Embodiment 1 of the present invention, with FIG. 1A showing the operation of the objective optical system when used with a first optical recording medium 9a, with FIG. 1B showing the operation of the objective optical system when used with a second optical recording medium 9b, with FIG. 1C showing the operation of the objective optical system when used with a third optical recording medium 9c, and with FIG. 1D showing the operation of the objective optical system when used with a fourth optical recording medium 9d;

FIG. 2 is a schematic diagram of an optical pickup optical system and an optical pickup device using the objective optical system of FIGS. 1A-1D;

FIGS. 3A-3D are schematic diagrams that depict cross-sectional views of the objective optical system of Embodiment 2 of the present invention, with FIG. 3A showing the operation of the objective optical system when used with a first optical recording medium 9a, with FIG. 3B showing the operation of the objective optical system when used with a second optical recording medium 9b, with FIG. 3C showing the operation of the objective optical system when used with a third optical recording medium 9c, and with FIG. 3D showing the operation of the objective optical system when used with a fourth optical recording medium 9d; and

FIG. 4 is a schematic diagram of an optical pickup optical system and an optical pickup device that are modified from the optical pickup optical system and the optical pickup device shown of FIG. 2.

### DETAILED DESCRIPTION

The present invention relates to an objective optical system for optical recording media that can be used to focus each of four light beams of four wavelengths, λ1, λ2, λ3, and λ4 from a light source to a different desired position for each of first, second, third, and fourth optical recording media of substrate thicknesses, T1, T2, T3, and T4, respectively, for recording and reproducing information. As herein defined, unless otherwise indicated, the term “light source” refers to the source of the four different light beams of at least four wavelengths (but not necessarily four different wavelengths), whether the light beams originate from a single light-emitting source or from separate light-emitting sources, such as semiconductor lasers. Additionally, the term “light source” may also include various optical elements, including beamsplitters, mirrors, and converging lenses, which for one or more of the light beams of wavelengths λ1, λ2, λ3, and λ4 may operate as a collimator lens to provide a collimated light beam incident on the objective optical system.

The objective optical system for optical recoding media includes, from the light source side: diffractive optics with at least one surface of the diffractive optics being a diffractive surface defined by a phase function Φ, as will be discussed in detail later; and an objective lens of positive refractive power with both surfaces being rotationally symmetric aspheric surfaces. The phase function Φ is chosen so that the objective optical system for optical recording media is able to focus each of the four light beams of four wavelengths, λ1, λ2, λ3, and λ4 at a different desired position for each of the first, second, third and fourth optical recording media of substrate thicknesses, T1, T2, T3, and T4, respectively.

The objective optical system for optical recording media is constructed so that collimated light of each wavelength, λ1, λ2, λ3, and λ4, diffracted by the diffractive optical element is efficiently focused onto the desired position of the corresponding optical recording media of substrate thickness, T1, T2, T3, and T4, respectively. In order for this to occur at all wavelengths, preferably the diffraction order of the diffracted light of at least one wavelength is different from the diffraction order of the diffracted light of at least one other wavelength.

Additionally, numerical apertures NA1, NA2, NA3, and NA4 of the objective optical system are associated with the wavelengths λ1, λ2, λ3, and λ4, respectively, and the substrate thickness of T1, T2, T3, and T4, respectively, of the four optical recording media.

In summary, throughout the following descriptions the following definitions apply:
NA1 is the numerical aperture of the objective optical system for light of the first wavelength λ1 that is focused on the optical recording medium of substrate thickness T1;
NA2 is the numerical aperture of the objective optical system for light of the second wavelength λ2 that is focused on the optical recording medium of substrate thickness T2;
NA3 is the numerical aperture of the objective optical system for light of the third wavelength λ3 that is focused on the optical recording medium of substrate thickness T3; and
NA4 is the numerical aperture of the objective optical system for light of the fourth wavelength λ4 that is focused on the optical recording medium of substrate thickness T4.

Additionally, in the objective optical system for optical recording media of the present invention, light beams of two wavelengths among the wavelengths λ1, λ2, λ3, and λ4 are the same or very nearly the same. The phrase “the same wavelength, or very nearly the same wavelength” means that the wavelengths may be considered the same, that is, equal to one another, for purposes of design, construction, and operation of the objective optical system. Furthermore, as exemplary and in accordance with the current use of wavelengths of light beams in objective optical systems for optical recording media, the wavelengths that are the same are taken as shorter wavelengths than the other two of the four wavelengths so that the following conditions are satisfied:
λ1=λ4<λ2<λ3 Condition (1)
NA4>NA1≧NA2>NA3 Condition (2)
T4<T1≦T2<T3 Condition (3).

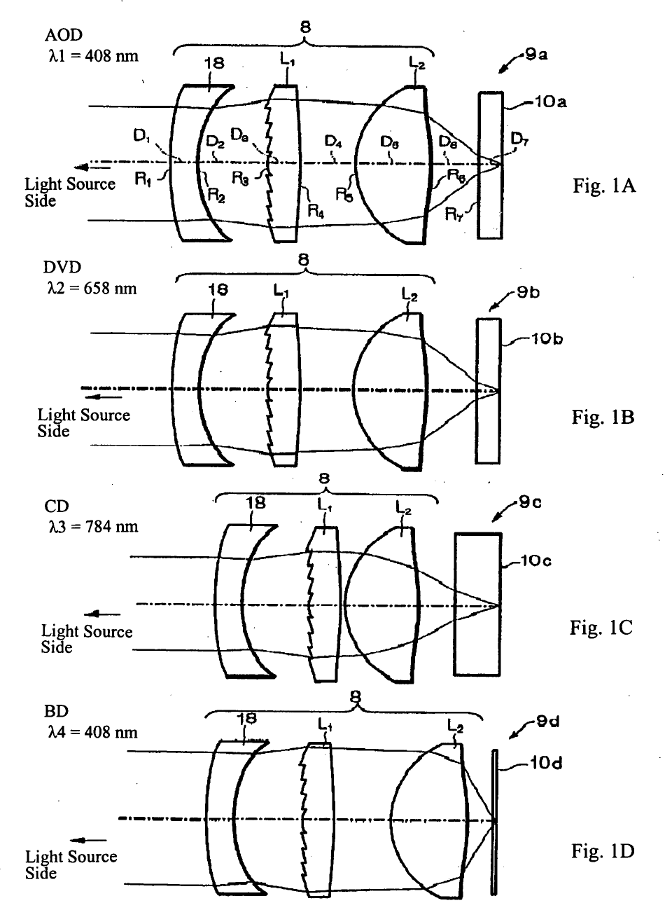

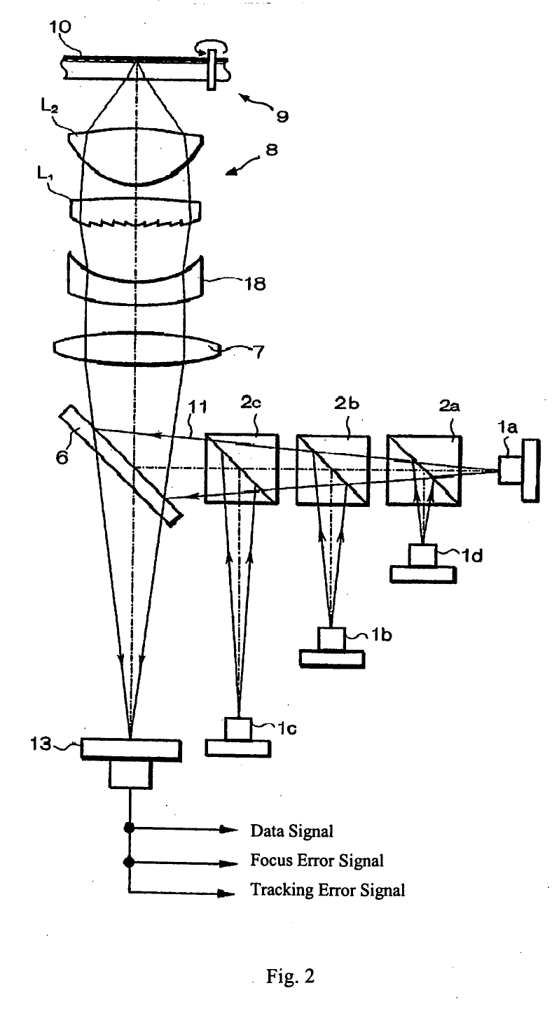

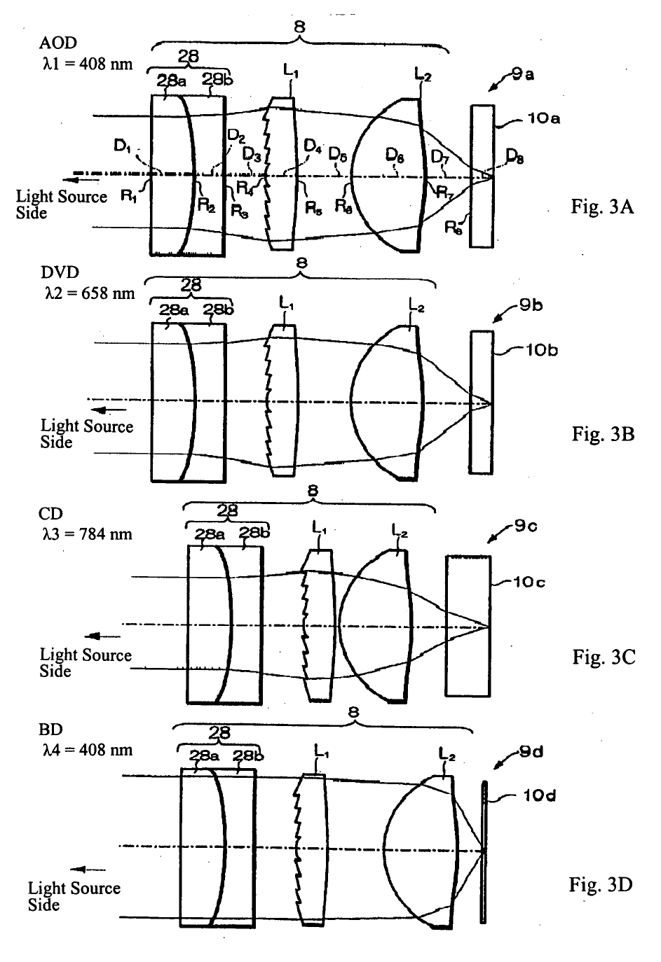

The invention will now be discussed in general terms with reference to FIGS. 1A-1D that show the geometry of the objective optical system of Embodiment 1 of the present invention and FIG. 2 that shows an optical pickup optical system and an optical pickup device using the objective optical system of this embodiment. The figures show the elements of the objective optical system schematically. In FIG. 1A, radii of curvature of the surfaces of the various optical elements, including the lens surfaces, are referenced by the letter R with a subscript denoting their order from the light source side of the objective optical system, from R₁ to R₇. The on-axis surface spacings along the optical axis of the various optical surfaces are referenced by the letter D with a subscript denoting their order from the light source side of the objective optical system, from D₁ to D₇. In FIG. 3A that shows Embodiment 2, the radii of curvature R₁ to R₈ and the on-axis surface spacings D₁ to D₈ are similarly indicated. In order to prevent FIG. 2 from being too complicated, only one pair of light rays of each light beam are illustrated at every location of the objective optical system in FIG. 2, even where light of more than one wavelength is present, including at the prisms 2a, 2b, and 2c. Additionally, in FIGS. 1A-1D and FIG. 2, a diffractive surface is shown as exaggerated in terms of an actual serrated shape in order to more clearly show the diffractive nature of the surface.

As shown in FIG. 2, a laser beam 11 that is emitted from one of the semiconductor lasers 1a, 1b, 1c, and 1d is reflected by a half mirror 6, is collimated by a collimator lens 7, and is focused by the objective optical system 8 onto a recording area 10 of an optical recording medium 9. Hereinafter, the term “collimated” means that any divergence or convergence of the light beam is so small that it can be neglected in computing the image-forming properties of the objective optical system 8 for the light beam. The laser beam 11 is converted to a convergent beam by the objective optical system 8 so that it is focused onto the recording region 10 of the optical recording medium 9.

More specifically, as shown in FIGS. 1A-1D, the arrangement includes an optical recording medium 9a that is an AOD with a substrate thickness T1 of 0.6 mm used with a light beam of wavelength λ1 that is equal to 408 nm and with a numerical aperture NA1 of 0.65 (FIG. 1A), an optical recording medium 9b that is a DVD with a substrate thickness T2 of 0.6 mm used with a light beam of wavelength λ2 that is equal to 658 nm and with a numerical aperture NA2 of 0.65 (FIG. 1B), an optical recording medium 9c that is a CD with a substrate thickness T3 of 1.2 mm used with a light beam of wavelength λ3 that is equal to 784 nm and with a numerical aperture NA3 of 0.50 (FIG. 1C), and an optical recording medium 9d that is a BD with a substrate thickness T4 of 0.1 mm used with a light beam of wavelength λ4 that is equal to 408 nm and with a numerical aperture NA4 of 0.85 (FIG. 1D).

The semiconductor laser 1a emits the visible laser beam having the wavelength of approximately 408 nm (λ1) for AODs. The semiconductor laser 1b emits the visible laser beam having the wavelength of approximately 658 nm (λ2) for DVDs. The semiconductor laser 1c emits the near-infrared laser beam having the wavelength of approximately 784 nm (λ3) for CDs such as CD-R (recordable optical recording media) (hereinafter the term CD generally represents CDs of all types). Additionally, the semiconductor laser 1d emits the visible laser beam having the wavelength of 408 nm (λ4) for BDs.

Furthermore, the optical pickup device and the optical pickup optical system of FIG. 2 are constructed so that the laser beam transmitted from each of the semiconductor lasers 1a to 1c has a first vibrational direction of polarization that is perpendicular to the second vibrational direction of polarization of the laser beam transmitted by the semiconductor laser 1d. The perpendicular directions lie in surfaces that are perpendicular to the direction of propagation of the laser beams.

The arrangement of FIG. 2 does not preclude semiconductor lasers 1a-1d providing simultaneous outputs. However, it is preferable that the lasers be used alternately depending on whether the optical recording media 9 of FIG. 2 is specifically, as shown in FIGS. 1A-1D, an AOD 9a, a DVD 9b, a CD 9c, or a BD 9d. In this manner, as shown with regard to FIGS. 1A and 1D, polarized light beams having different vibrational directions of polarization are alternately received by the objective optical system for focusing on two different types of optical recording media having different substrate thicknesses. In the present invention, within the objective optical system, divergence is introduced to or increased for at least one of the polarized light beams having different vibrational directions of polarization so that another of said polarized light beams having a different vibrational direction of polarization does not have divergence of the same magnitude as the at least one of the polarized light beams having different vibrational directions of polarization so as to enable focusing of different ones of said polarized light beams on different types of optical recording media having different substrate thicknesses. As shown in FIG. 2, the laser beam 11 transmitted from the semiconductor laser 1a or 1d is irradiated onto the half mirror 6 via the prisms 2a, 2b and 2c; the laser beam 11 transmitted from the semiconductor laser 1b is irradiated onto the half mirror 6 via the prisms 2b and 2c; and the laser beam 11 transmitted from the semiconductor laser 1c is irradiated onto the half mirror 6 via the prism 2c.

The collimator lens 7 is schematically shown in FIG. 2 as a single lens element. However, it may be desirable to use a collimator lens made up of more than one lens element in order to better correct chromatic aberration of the collimator lens 7. In general, the constitution of the objective optical system for optical recording media is illustrated as simply as possible in terms of lens elements in FIGS. 1A-1D.

In the optical pickup device of the present invention, each of the optical recording media 9, as shown in FIG. 2, whether an AOD 9a, a DVD 9b, a CD 9c, or a BD 9d, as shown in FIGS. 1A-1D, respectively, must be arranged at a predetermined position along the optical axis, for example, on a turntable, so that the recording region 10 of FIG. 2 (one of recording regions 10a, 10b, 10c, and 10d of an AOD 9a, a DVD 9b, a CD 9c, and a BD 9d of FIGS. 1A-1D, respectively) is positioned at the focus of the light beam of the corresponding wavelength (λ1, λ2, λ3, and λ4 for recording regions 10a, 10b, 10c, and 10d, respectively) in order to properly record signals and reproduce recorded signals. The light beams enter the objective optical system 8 for optical recording media as collimated light so that the objective optical system 8 operates with an infinite conjugate on the light source side. Due to the diffractive effects and the refractive effects of diffractive optics L₁ and the refractive effects of objective lens L₂, each of which in FIGS. 1A-1D and FIG. 2 is shown as a lens element that is a lens component, each light beam is efficiently focused on the appropriate corresponding recording medium, AOD 9a as shown in FIG. 1A, DVD 9b as shown in FIG. 1B, CD 9c as shown in FIG. 1C, or BD 9d as shown in FIG. 1D.

In the recording region 10, pits carrying signal information are arranged in tracks. The reflected light of a laser beam 11 from the recording region 10 is made incident onto the half mirror 6 by way of the objective optical system 8 and the collimator lens 7 while carrying the signal information, and the reflected light is transmitted through the half mirror 6. The transmitted light is then incident on a four-part photodiode 13. The respective quantities of light received at each of the four parts of the four-part photodiode 13 are converted to electrical signals that are operated on by calculating circuits (not shown in the drawings) in order to obtain data signals and respective error signals for focusing and tracking.

Because the half mirror 6 is inserted into the optical path of the return light from the optical recording media 9 at a forty-five degree angle to the optical axis, the half mirror 6 introduces astigmatism into the light beam, as a cylindrical lens may introduce astigmatism, whereby the amount of focusing error may be determined according to the form of the beam spot of the return light on the four-part photodiode 13. Also, a grating may be inserted between the semiconductor lasers 1a-1d and the half mirror 6 so that tracking errors can be detected using four beams.

As shown in FIGS. 1A-1D and FIG. 2, the objective optical system 8 for optical recording media of the present invention includes, in order from the light source side, light convergence or divergence effect adjusting element 18, light diffractive optics L₁ that includes one diffractive surface, and objective lens L₂ having positive refractive power, which is on the recording media side of the objective optical system. The light convergence or divergence effect adjusting element 18 provides a different light convergence or divergence effect based on a difference in the vibrational direction of the polarization of the incident light. Specifically, the vibrational directions are perpendicular to one another. These different light convergence or divergence effects for two polarized light beams whose vibrational directions of polarization are perpendicular to one another may be produced by the light convergence or divergence effect adjusting element 18 being a crystalline optical member such as a birefringent uniaxial crystal (e.g., crystallized quartz). The optic axis of the crystal is established so as to enable making one polarized light beam to define a first vibrational direction of polarization associated with an extraordinary ray of light and the other polarized light beam to define a second vibrational direction of polarization associated with an ordinary ray of light. The different light convergence or divergence effects result from the differences of the refractive indexes of the crystal material for the extraordinary ray and the ordinary ray.

For example, as shown in FIGS. 1A-1D, in the case of selecting the AOD 9a, the polarized light beam having the first vibrational direction of polarization is used; in contrast, in the case of selecting the BD 9d, the polarized light beam having the second vibrational direction of polarization, which is perpendicular to the first vibrational direction of polarization, is used. Because the light convergence or divergence effect adjusting element 18 is designed to provide a different light convergence or divergence effect according to the vibrational direction of polarization, it is possible to make light focus or converge excellently onto the recording region 10 even with light beams having the same or very nearly the same wavelength whether the recording region 10 is that of the AOD 9a whose substrate thickness is 0.6 mm or that of the BD 9d whose substrate thickness is 0.1 mm while still controlling the generation of spherical aberration and preventing excessive residual spherical aberration with any substrate thickness. Thus the light beams can be efficiently focused onto all the recording media.

As described above, the AOD 9a and the BD 9d may use the same or very nearly the same wavelength of light for recording or reproducing information. This makes it difficult to adopt conventional methods of changing the refractive effect or the diffractive effect of the objective optical system for optical recording media according to the wavelength of the light in order to change the position of focus of the light. The present invention overcomes these problems and is very effective because it does not depend upon changing the wavelength of the light being used for two different recording media of different substrate thicknesses.

In addition, the present invention can be applied not only to multiple optical recording media wherein the wavelengths of the light beams to be used are the same, but it can also be applied to multiple optical recording media that include light beams to be used with wavelengths that are different from one another.

Additionally, in Embodiment 1 as shown in FIGS. 1A-1D, the light beams to be used for the DVD 9b and the CD 9c are polarized light beams having the first vibrational direction of polarization, the same as the light beam used for the AOD 9a. Even in the case of recording on or reproducing information from the DVD 9b or the CD 9c, the objective optical system is constructed such that light beams for the DVD 9b and the CD 9c are also efficiently converged and focused onto the recording region 10.

Furthermore, instead of using crystallized quartz as the light convergence and divergence effect adjusting element in the objective optical system for optical recording media of the present invention, various other uniaxial crystals with appropriate differences of refractive indexes between the extraordinary ray and the ordinary ray can be used. In addition, as the light convergence and divergence effect adjusting element in the objective optical system for optical recording media of the present invention, an element wherein the refractive index changes according to the vibrational direction of polarization may result in no refraction at an optical element interface of the light convergence and divergence adjusting element for the extraordinary ray or the ordinary ray, as shown, for example, in FIG. 3D that shows Embodiment 2 of the present invention.

In the objective optical system for optical recording media of the present invention, when the three optical recording media 9a, 9b, and 9c are used with light beams having the first vibrational direction of polarization and the optical recording medium of FIG. 1A (namely, the AOD 9a) and the optical recording medium of FIG. 1B (namely, the DVD 9b) have the same substrate thickness of 0.6 mm, the separation D₄ between the diffractive optical element L₁ and the objective lens L₂ is established to be the same or very nearly the same for recording or reproducing information. However, in the case of recording information on or reproducing information from the CD 9c of FIG. 1C, wherein the substrate thickness of the recording medium is thicker, for example 1.2 mm, the separation D₄ between the diffractive optical element L₁ and the objective lens L₂ is established to be smaller.

According to the present invention, changing the separation between the diffractive optical element L₁ and the objective lens L₂ according to the type of the recording medium being used enables collimated light to be incident on the objective optical system 8 for all the optical recording media being used and also enables light to be focused by the objective optical system 8 for optical recording media at desired predetermined positions with excellent correction of aberrations.

As described above, according to the objective optical system 8 for optical recording media of the present embodiment, even in the case of recording to or reproducing from any one of the optical recording media, AOD 9a, DVD 9b, CD 9c, or BD 9d, the light being used can enter into the objective optical system 8 for optical recording media as collimated light so that the degree of freedom in selecting optical elements of the optical system and arranging these elements can be enhanced, so that a compact device can be obtained, and so that tracking ability can be improved.

In addition, designing the diffractive optical element L₁ to have a positive refractive power as a whole enables objective lens L₂ to have less positive refractive power, which also results in a smaller size of the entire objective optical system 8 for optical recording media.

Furthermore, by designing the diffractive optical element L₁ to have a negative refractive power as a whole, the operating distance can be made longer, which helps prevent the objective lens L₂ from colliding with the optical recording media, for example, a disc optical recording media.

Additionally, the diffractive surface of the diffractive optics L₁ preferably is designed so that the diffractive surface diffracts light of maximum intensity for the first wavelength λ1 and for the fourth wavelength λ4 at a diffraction order that is different from the diffraction order of maximum intensity for the second wavelength λ2 and that is different from the diffraction order of maximum intensity for the third wavelength λ3. The four light beams can be focused to appropriate desired positions with high diffraction efficiency by setting the diffraction orders of maximum intensity diffracted light as described above.

Furthermore, it is preferable that the diffractive surface of the objective optical system 8 for optical recording media of the present invention be formed as a diffractive structure on a ‘virtual plane’, herein defined as meaning that the surface where the diffractive structure is formed would be planar but for the diffractive structures of the diffractive surface, and that the virtual plane be perpendicular to the optical axis. Preferably, the cross-sectional configuration of the diffractive surface is serrated so as to define a so-called kinoform. FIGS. 1A-1D and FIG. 2 exaggerate the actual size of the serrations of the diffractive surfaces.

The diffractive surface is defined by the phase function Φ. The diffractive surface adds a difference in optical path length equal to m·λ·Φ/(2π) to the diffracted light, where λ is the wavelength, Φ is the phase function of the diffractive surface, and m is the order of the diffracted light that is focused on a recording medium 9. The phase function Φ is given by the following equation:
Φ=ΣWᵢ·Y²ⁱ Equation (A)
where
Y is the distance in mm from the optical axis; and
Wᵢ is a phase function coefficient, and the summation extends over i.

Furthermore, the specific heights of the serrated steps of the diffractive surface of the diffractive optical element that forms diffractive optics L₁ are based on ratios of diffracted light of each order for the light beams of wavelengths λ1, λ2, λ3, and λ4. Additionally, the outer diameter of the diffractive surface can be appropriately determined by taking into consideration the numerical aperture (NA) of the objective optical system 8 for optical recording media and the beam diameter of the incident laser beams 11 of each of the used wavelengths.

Furthermore, it is preferable that at least one surface of the objective lens L₂ of the objective optical system 8 for optical recording media of the present invention be an aspheric surface. It is also preferable that the aspheric surfaces be rotationally symmetric aspheric surfaces defined using the following aspherical equation in order to improve aberration correction for all of the recording media 9a, 9b, 9c, and 9d and in order to assure proper focusing during both recording and reproducing operations:
Z=[(C−Y²)/{1+(1−K·C²·Y²)^{1/2}}]+ΣAᵢ·Y²ⁱ Equation (B)
where
Z is the length (in mm) of a line drawn from a point on the aspheric lens surface at a distance Y from the optical axis to the tangential plane of the aspheric surface vertex,
C is the curvature (=1/the radius of curvature, R in mm) of the aspheric lens surface on the optical axis,
Y is the distance (in mm) from the optical axis,
K is the eccentricity, and
Aᵢ is an aspheric coefficient, and the summation extends over i.

It is preferable that the diffractive surface or diffractive surfaces formed on the diffractive optical element L₁ and the rotationally symmetric aspheric surface or surfaces formed on the diffractive optical element L₁ and/or the objective lens L₂ are determined so as to focus each of the four beams of light with the four wavelengths, λ1, λ2, λ3, and λ4, on a corresponding recording region 10, as shown in FIG. 2 (10a, 10b, 10c, 10d as shown in FIGS. 1A-1D, respectively) with excellent correction of aberrations.

Additionally, in the objective optical system 8 for optical recording media of the present invention, either one or both of the diffractive optical element L₁ and the objective lens L₂ may be made of plastic. Making these optical elements of plastic is advantageous in reducing manufacturing costs and making manufacturing easier, and in making the system lighter, which may assist in high speed recording and replaying. Also, it is especially advantageous to use plastic because this enables using a mold to form the diffractive optical element, which is associated with molding processes that are much easier than many other processes of manufacturing.

Alternatively, one or both of the diffractive optical element L₁ and the objective lens L₂ may be made of glass. Glass is advantageous for several reasons, including the fact that optical properties of glass generally vary less with changing temperature and humidity than for plastic, and the fact that deterioration of the transmissivity is small compared to plastic even when the diffractive optical element L₁ and/or the objective lens L₂ is used for long periods of time, even when light beams of relatively short wavelengths are used.

Embodiments 1 and 2 of the objective optical system 8 for optical recording media of the present invention will now be set forth in detail.

### EMBODIMENT 1

FIGS. 1A-1D are schematic diagrams that depict cross-sectional views of the objective optical system of Embodiment 1 of the present invention, with FIG. 1A showing the operation of the objective optical system when used with a first optical recording medium 9a, with FIG. 1B showing the operation of the objective optical system when used with a second optical recording medium 9b, with FIG. 1C showing the operation of the objective optical system when used with a third optical recording medium 9c, and with FIG. 1D showing the operation of the objective optical system when used with a fourth optical recording medium 9d. As shown in FIGS. 1A-1D, the objective optical system of Embodiment 1 is formed of, in order from the light source side, the light convergence or divergence effect adjusting element 18, the diffractive optical element L₁, and the objective lens L₂.

The light convergence or divergence effect adjusting element 18 is formed from crystallized quartz to define a crystalline optical member and is a meniscus lens element having negative refractive power and having its convex surface on the light source side. The optic axis of the light convergence or divergence effect adjusting element 18 is arranged so that polarized light beams having the first vibrational direction of polarization associated with an extraordinary ray of light, subject to a refractive index Ne equal to 1.567, are used with recording media 9a, 9b, and 9c, which are an AOD, a DVD, and a CD, respectively, and so that a polarized light beam having the second vibrational direction of polarization associated with an ordinary ray of light, subject to a refractive index No equal to 1.557, is used with recording media 9d, which is a BD. Different light convergence or divergence effects result from the differences of the refractive indexes of the crystal material for the extraordinary ray and the ordinary ray so that the polarized beams are properly focused on the particular recording media, 9a, 9b, 9c, or 9d, being used.

Furthermore, the diffractive optical element L₁ has positive refractive power as a whole, with the surface on the light source side being a diffractive surface formed as a diffractive structure on a virtual plane that is perpendicular to the optical axis and the surface on the recording medium side being a rotationally symmetric aspheric convex surface. The diffractive surface being formed as a diffractive structure on a virtual plane means that the surface where the diffractive structure is formed is planar but for the diffractive structures of the diffractive surface, and the virtual plane is perpendicular to the optical axis. Additionally, the objective lens L₂ is a biconvex lens element, which has positive refractive power, with a rotationally symmetric aspheric surface on each side.

The diffractive surface is defined by the phase function Φ defined by Equation (A) above and the rotationally symmetric aspheric surfaces are defined by Equation (B) above. The diffractive surface is formed with a cross-sectional configuration of concentric serrations that define a grating.

As indicated in FIGS. 1A-1D, the objective optical system 8 for optical recording media favorably focuses light of each wavelength, λ1 and λ4 of 408 nm, λ2 of 658 nm, and λ3 of 784 nm, onto a respective recording region 10a, 10d, 10b, and 10c of respective recording media 9a, 9d, 9b, and 9c which are an AOD, a BD, a DVD, and a CD, respectively. Additionally, in order to avoid complications in the diagrams, reference symbols of the radii of curvature R and on-axis surface spacings D have been omitted in FIGS. 1B-1D.

As shown in FIGS. 1A-1D, the objective optical system operates with an infinite conjugate on the light source side with the substantially collimated light beams of all four wavelengths being incident on the objective optical system 8 for optical recording media. Additionally, as shown in FIGS. 1A-1D, each of the light beams is used separately according to the optical recording media 9 being used.

As shown in FIGS. 1A-1D, the configuration is such that the separation D₄ between the diffractive optical element L₁ and the objective lens L₂ is different, becoming smaller only in the case of selecting the CD 9c.

The objective optical system of Embodiment 1 can control the generation of spherical aberration and at the same time focus the light onto a desired position on the appropriate one of the four types of recording media, 9a, 9b, 9c, or 9d, being used.

### EMBODIMENT 2

FIGS. 3A-3D are schematic diagrams that depict cross-sectional views of the objective optical system for optical recording media of Embodiment 2 of the present invention, with FIG. 3A showing the operation of the objective optical system when used with a first optical recording medium 9a, with FIG. 3B showing the operation of the objective optical system when used with a second optical recording medium 9b, with FIG. 3C showing the operation of the objective optical system when used with a third optical recording medium 9c, and with FIG. 3D showing the operation of the objective optical system when used with a fourth optical recording medium 9d. As shown in FIGS. 3A-3D, the objective optical system for optical recording media of Embodiment 2 is formed of, in order from the light source side, the light convergence or divergence effect adjusting element 28, the diffractive optical element L₁, and the objective lens L₂. The objective lens L₂ of this embodiment is identical to the objective lens L₂ of Embodiment 1. In FIGS. 3A-3D, the same reference symbols are used for optical elements and optical recording media that are the same, or are illustrated in the same manner, as in FIGS. 1A-1D, and further explanation of these elements and these media will be omitted.

The convergence or divergence effect adjusting element 28 is formed in two parts, a planar-convex lens element 28a formed of amorphous glass having its planar surface on the light source side and its convex surface abutting and joined to on its optical recording media side the concave surface of a planar-concave lens element 28b formed of crystallized quartz. The planar-concave lens element 28b defines a crystalline optical member. The refractive index of the amorphous lens element 28a for light of wavelength 408 nm is equal to the refractive index for an ordinary ray (No) of the crystalline lens element 28b, which is 1.557. Furthermore, the refractive index for an extraordinary ray (Ne) for light of wavelength 408 nm of the crystalline lens element 28b is equal to 1.567.

For polarized light with the first vibrational direction of polarization, which is the light to be used for the AOD 9a, the DVD 9b and the CD 9c, polarized light that enters the light convergence or divergence effect adjusting element 28 becomes extraordinary light rays within the crystalline lens element 28b. Thereby, a difference of the refractive indexes is generated between the planar-convex amorphous lens element 28a and the planar-concave crystalline optical member or crystalline lens element 28b, and the light becomes a slightly divergent light on the boundary surface of both lens elements. In contrast, for polarized light with the second vibrational direction of polarization, which is the light to be used for the BD 9d, polarized light that enters the light convergence or divergence effect adjusting element 28 becomes ordinary rays of light within the crystalline lens 28b. Thereby, no difference of the refractive indexes is generated between the planar-convex amorphous lens element 28a and the planar-concave crystalline optical member or crystalline lens element 28b, and the light rays travel straight across the boundary surface of both lens elements.

As described above, the light convergence or divergence effect of the light convergence or divergence effect adjusting element 28 is different between the case that a first vibrational direction of polarization transmitted by the crystalline optical member defines an extraordinary ray of light and light transmitted with a second vibrational direction of polarization transmitted by the crystalline optical member defines an ordinary ray of light. The design is such that this difference enables excellent focusing of the light at desired positions for each of the optical recording media 9a, 9b, 9c, and 9d in Embodiment 2.

Furthermore, the objective optical system for optical recording media of the present invention is not limited to the specific Embodiments 1 and 2 described above, and various modifications can be made. Additionally, the optical pickup optical system and the optical pickup device of the present invention are similarly modifiable.

For example, regarding the objective optical system for optical recording media of the present invention, information is recorded or reproduced with light beams with the same or nearly the same wavelengths with optical recording media having different thicknesses. However, in the case where there are three more types of optical recording media, appropriate changes can also be made in the separation between lens groups in order to assure proper focusing on different recording media by the objective optical system. Furthermore, even when using different light beams, no particular limit is placed on the number of different recording media that can be used with the objective optical system of the present invention.

Needless to say, the objective optical system for optical recording media of the present invention is particularly suitable for use with multiple recording media that use the same wavelength of light for recording and reproducing information. However, the present invention does not exclude the objective optical system from being used with all the wavelengths of light used with the different optical recording media being different from one another.

Additionally, although in Embodiments 1 and 2 described above, the light beams enter the objective optical system as collimated light beams, one or more of the light beams may also enter the objective optical system as divergent light or convergent light.

Furthermore, although in Embodiment 2 described above the planar-convex lens element 28a formed of amorphous glass has its convex surface on the optical recording media side joined to the concave surface of the planar-concave crystalline optical member or crystalline lens element 28b formed of crystallized quartz to define the light convergence or divergence effect adjusting element 28, the construction is not limited to such an example. For instance, it is possible to exchange the positions of the amorphous lens element and the crystalline lens element and to have the curved boundary surface convex toward either the light source side or the recording media side. Additionally, this curved surface is not limited to a spherical surface, but it can be an aspheric surface. In addition, the refractive index of the amorphous lens element can be established so as to be different than the refractive index of the ordinary ray in the crystalline lens element and to be the same as the refractive index of the extraordinary ray in the crystalline lens element. Furthermore, the refractive index of the amorphous lens element can be established so as to be different than both the refractive indexes of the extraordinary ray and the ordinary ray in the crystalline lens element. The primary consideration is to have a configuration that enables controlling the spherical aberration on the recording region 10 of any optical recording media 9.

Furthermore, it is possible to change the planar shape of the light incidence surface and/or the light exit surface of each of the lens elements 28a and 28b to a curved surface.

Also, although in Embodiments 1 and 2 of the present invention described above the objective optical system other than the light convergence or divergence effect adjusting element is formed of two lens groups, the objective optical system may, for example, be formed of only one lens group or three or more lens groups. Additionally, in the case of the one-group configuration, the one lens group can be joined to the diffractive optical element.

In addition, the diffractive optical surface can be formed on any lens surface of the objective optical system.

Furthermore, this diffractive optical surface can be formed on a convex or concave surface having a refractive power, and it can be formed on an aspheric surface. Also, although a rotationally symmetric aspherical surface is used as the surface that is not the diffractive optical surface of the diffractive optical element in Embodiments 1 and 2 described above, this surface can be a planar surface, a spherical surface, or a non-rotationally symmetric aspheric surface. For example, it is possible to form the diffractive optical surface on a lens surface having a refractive power and to form an aspherical surface on the other surface of the lens. Further, both surfaces of the diffractive optical element may be diffractive optical surfaces.

The diffractive surface of the objective optical system should be constructed so as to output a considerable quantity of diffracted light of the desired orders of diffracted light for the appropriate wavelengths, with 100% diffracted light of each appropriate order being the ideal. Additionally, the structure of the diffractive optical element is not limited to the serrated one, but, for example, a stair-stepped structure may also be used.

In addition, the objective optical system for optical recording media may be configured so that none of the lens groups includes a diffractive surface.

Furthermore, for the objective lens of the objective optical system for optical recording media, the configuration is not limited to the one wherein both the surface on the light source side and the surface on the optical recording medium side are rotationally symmetric aspheric surfaces. For example, a planar surface, a spherical surface, or a non-rotationally symmetric aspheric surface may be appropriately used.

Additionally, in the future, as the optical recording media, a medium other than the above-mentioned ones (for example, a medium wherein the wavelength of a light to be used is much shorter) may be developed, and even in such a case, it is clear that the present invention can be applied. In this case, as a lens material, it is preferable to use a material that has an excellent transmissivity for the wavelength of light to be used. For example, it is possible to use fluorite or quartz as a lens material of the objective optical system for optical recording media of the present invention.

Furthermore, in the optical pickup optical system and the optical pickup device related to Embodiments 1 and 2 described above, four light sources are used. However, a single light source that can transmit two light beams with different wavelengths from one another, for example, from adjacent output ports, may be used. In this case, instead of the prisms 2b and 2c shown in FIG. 2, a single prism, for example, may be used. In addition, one light source that can transmit three light beams with different wavelengths from one another from adjacent output ports may be used. In this case, the prisms 2b and 2c shown in FIG. 2 become unnecessary.

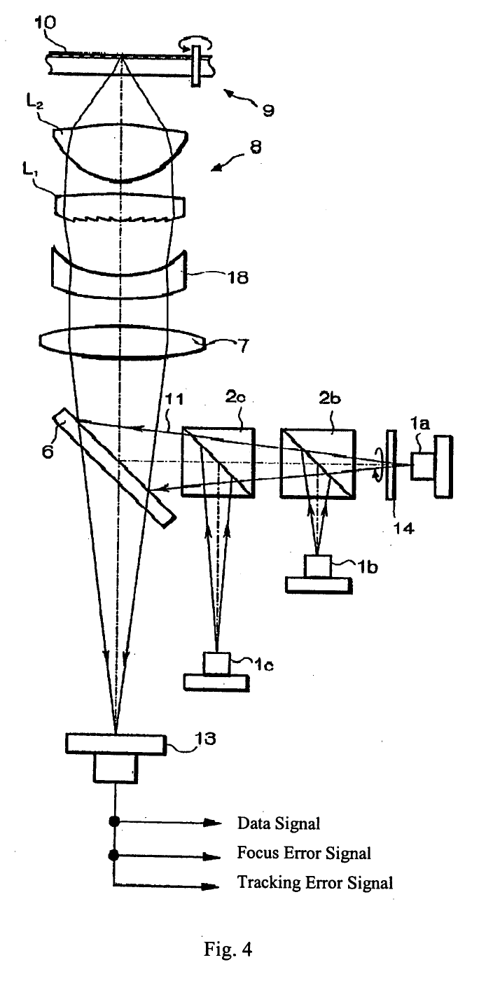

Additionally, it is possible to use a single light source for the optical recording media 9 that use light of the same wavelength, for example, the AOD 9a and the BD 9d as shown in FIG. 4 that is a schematic diagram of an optical pickup optical system and an optical pickup device modified from that of FIG. 2. In FIG. 4, features corresponding to features shown in FIG. 2 use the same reference symbols and their descriptions are omitted.

As shown in FIG. 4, a light source 1a transmitting a laser beam with 408 nm of wavelength for the AOD 9a is also used as a light source transmitting a laser beam with 408 nm of wavelength for the BD 9d. A λ/2 wavelength plate 14 is arranged to be rotatable about the optical axis at the light transmission side of this light source 1a. In the case that the light source 1a is used for the AOD 9a, this λ/2 wavelength plate 14 is set at a first rotational angle position that can transmit light of the above-mentioned first vibrational direction of polarization, and in the case that the light source 1a is used for the BD 9d, this λ/2 wavelength plate 14 is set at a second rotational angle position rotated in a predetermined direction forty-five degrees from the first rotational angle position.

Furthermore, this λ/2 wavelength plate 14 functions as a polarization switching element to switch the vibrational direction of polarization of the polarized light. However, as a mode of the polarizing switching, other polarizing switching devices may be used as long as they can alternately transmit two polarized light beams having vibrational directions of polarization perpendicular to one another. For example, a liquid crystal element that can switch the vibrational direction of an incident light beam according to the ON/OFF state of a voltage applied to the liquid crystal element, such as a twisted nematic liquid crystal element, can be used.

Furthermore, the optical pickup optical system and the optical pickup device can be designed to use one light source that can transmit three light beams with different wavelengths from one another from adjacent outlet ports. In this case, the number of prisms required can be reduced.

Additionally, although in embodiments of the present invention described above, an extraordinary ray is used for an AOD, a DVD and a CD, and an ordinary ray is used for a BD, it is also possible to use an ordinary ray for an AOD, a DVD and a CD and to use an extraordinary ray for a BD while using light beams with a different state of polarization for the DVD and the AOD relative to that for the CD and the AOD.

Furthermore, in the case wherein light sources independent from one another are used, for example, as light sources transmitting light to be used for the AOD 9a and the BD 9d, the wavelengths of the light beams to be transmitted from each light source should be almost the same, but it is not necessary that they be exactly the same.

Furthermore, in the optical pickup device, an aperture and/or aperture control device that has a wavelength selectivity may be arranged at the light source side of the objective optical system, or the aperture or aperture control device may be incorporated in the diffractive optics L₁ or in the objective lens L₂.

Furthermore, in the objective optical system for optical recording media of the present invention, the optical pickup optical system and the optical pickup device using this optical pickup optical system is acceptable as long as the objective optical system for optical recording media is constructed so as to provide a different light convergence or divergence effect according to the vibrational direction of polarization of two incident polarized light beams, and the objective lens itself may vary the light convergence or divergence effects based on vibrational direction of polarization determined by the light convergence or divergence adjusting element.

Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An objective optical system for focusing light from a light source onto at least two different types of optical recording media having different substrate thicknesses in order to record information on, or reproduce information from, the at least two different types of optical recording media, wherein:
the objective optical system is constructed so as to have a different light convergence or divergence effect based on a difference in the vibrational direction of the polarization of polarized incident light;
polarized light beams having different vibrational directions of polarization are alternately received by the objective optical system for focusing onto the at least two different types of optical recording media having different substrate thicknesses; and
within the objective optical system, convergence or divergence is introduced to, or increased or decreased for, at least one of said polarized light beams having different vibrational directions of polarization so that another of said polarized light beams having a different vibrational direction of polarization does not have divergence of the same magnitude as said at least one of said polarized light beams having different vibrational directions of polarization so as to enable focusing of different ones of said polarized light beams onto different types of optical recording media having different substrate thicknesses.

2. An objective optical system for focusing light from a light source onto at least two different types of optical recording media having different substrate thicknesses in order to record information on, or reproduce information from, the at least two different types of optical recording media, wherein:
the objective optical system is constructed so as to focus light with the same or very nearly the same wavelength onto at least two types of optical recording media having different substrate thicknesses in order to record on, or reproduce information from, said at least two types of optical recording media;
the objective optical system is constructed so as to have a different light convergence or divergence effect based on a difference in the vibrational direction of the polarization of polarized incident light;
polarized light beams having different vibrational directions of polarization are alternately received by the objective optical system for focusing onto the at least two different types of optical recording media having different substrate thicknesses; and
within the objective optical system, convergence or divergence is introduced to, or increased or decreased for, at least one of said polarized light beams having different vibrational directions of polarization so that another of said polarized light beams having a different vibrational direction of polarization does not have divergence of the same magnitude as said at least one of said polarized light beams having different vibrational directions of polarization so as to enable focusing of different ones of said polarized light beams onto different types of optical recording media having different substrate thicknesses.

3. The objective optical system of claim 2, wherein:
the objective optical system includes a light source side and a recording media side that is opposite the light source side;
a light convergence or divergence effect adjusting element provides a different light convergence or divergence effect based on a difference in the vibrational direction of the polarization of polarized incident light; and
an objective lens system is arranged on the recording media side of the light convergence or divergence effect adjusting element.

4. The objective optical system of claim 2, wherein:
polarized light with a first vibrational direction of polarization is intended to be focused onto one of said at least two types of optical recording media;
polarized light with a second vibrational direction of polarization is intended to be focused onto another of said at least two types of optical recording media; and
said first vibrational direction and said second vibrational direction are perpendicular to one another.

5. The objective optical system of claim 3, wherein:
said light convergence or divergence effect adjusting element is a crystalline optical member; and
the crystalline optical member includes an optic axis and said optic axis is arranged so that polarized light with a first vibrational direction of polarization transmitted by the crystalline optical member defines an extraordinary ray of light, and polarized light with a second vibrational direction of polarization transmitted by the crystalline optical member defines an ordinary ray of light.

6. The objective optical system of claim 3, wherein:
said light convergence or divergence effect adjusting element includes a crystalline optical member that is joined to an amorphous optical element at abutting curved surfaces;
the crystalline optical member includes an optic axis and said optic axis is arranged so that polarized light with a first vibrational direction of polarization transmitted by the crystalline optical member defines an extraordinary ray of light, and polarized light with a second vibrational direction of polarization transmitted by the crystalline optical member defines an ordinary ray of light; and
the refractive index of the amorphous optical element is the same, or very nearly the same, as the refractive index of said crystalline optical member for said ordinary ray of light or said extraordinary ray of light.

7. The objective optical system of claim 2, wherein said at least two different types of optical recording media having different substrate thicknesses are among at least four different types of optical recording media that the objective optical system is designed for focusing light from a light source onto in order to record information on, or reproduce information from, the optical recording media.

8. The objective optical system of claim 7, wherein:
one of the said at least two types of optical recording media is an AOD; and
another of said at least two types of optical recording media is a BD.

9. An optical pickup optical system that includes the objective optical system of claim 4, wherein:
a first light source transmits said polarized light with a first vibrational direction of polarization;
a second light source transmits said polarized light with a second vibrational direction of polarization; and
said different light convergence or divergence effect of said objective optical system is based on whether said polarized light with a first vibrational direction of polarization or said polarized light with a second vibrational direction of polarization is focused by the objective optical system.

10. An optical pickup optical system that includes the objective optical system of claim 4, wherein:
a light source transmits said polarized light with a first vibrational direction of polarization and said polarized light with a second vibrational direction of polarization;
a polarization switching element switches the vibrational direction of polarization of polarized light from said first vibrational direction of polarization to said second vibrational direction of polarization in order for the polarized light to be focused onto different ones of said at least two types of optical recording media; and
said different light convergence or divergence effect of said objective optical system is based on whether said polarized light with a first vibrational direction of polarization or said polarized light with a second vibrational direction of polarization is transmitted from the polarization switching element.

11. The optical pickup optical system of claim 10, wherein the objective optical system includes a light source side and a recording media side that is opposite the light source side, and the objective optical system comprises:
a light convergence or divergence effect adjusting element that provides a different light convergence or divergence effect based on whether said light source transmits said polarized light with a first vibrational direction of polarization or said polarized light with a second vibrational direction of polarization; and
an objective lens system is arranged on the recording media side of the light convergence or divergence effect adjusting element.

12. The optical pickup optical system of claim 10, wherein the polarization switching element includes a λ/2 wavelength plate that is rotatable about an optical axis of transmitted light.

13. The optical pickup optical system of claim 10, wherein the polarization switching element includes a liquid crystal element for switching the vibrational direction of polarization of an incident polarized light beam from said first vibrational direction of polarization to said second vibrational direction of polarization according to an ON/OFF state of applied voltage to the liquid crystal element.

14. The optical pickup optical system of claim 11, wherein said light convergence or divergence effect adjusting element is a crystalline optical member; and
the crystalline optical member includes an optic axis and said optic axis is arranged so that said polarized light with a first vibrational direction of polarization is transmitted by the crystalline optical member so as to define an extraordinary ray of light, and said polarized light with a second vibrational direction of polarization is transmitted by the crystalline optical member so as to define an ordinary ray of light.

15. The optical pickup optical system of claim 11, wherein said light convergence or divergence effect adjusting element includes a crystalline optical member that is joined to an amorphous optical element at abutting curved surfaces;
the crystalline optical member includes an optic axis and said optic axis is arranged so that said polarized light with a first vibrational direction of polarization is transmitted by the crystalline optical member so as to define an extraordinary ray of light, and said polarized light with a second vibrational direction of polarization is transmitted by the crystalline optical member so as to define an ordinary ray of light; and
the refractive index of the amorphous optical element is the same or very nearly the same as the refractive index of said crystalline optical member for one of said ordinary ray of light or said extraordinary ray of light.

16. The optical pickup optical system of claim 9, wherein said at least two different types of optical recording media having different substrate thicknesses are among at least four different types of optical recording media that the optical pickup optical system is designed for focusing polarized light from a light source onto in order to record information on, or reproduce information from, the optical recording media.

17. The optical pickup optical system of claim 16, wherein:
one of the said at least two types of optical recording media is an AOD; and
another of said at least two types of optical recording media is a BD.

18. An optical pickup device that includes the optical pickup optical system of claim 9.

19. An optical pickup device that includes the optical pickup optical system of claim 10.

20. An optical pickup device that includes the optical pickup optical system of claim 17.
